(19) United States
(12) Patent Application Publication
(10) Pub. No.: US 2012/0141071 A1
(43) Pub. Date: Jun. 7, 2012

(54) OPTICAL CONNECTOR

(75) Inventors: Jeroen Antonius Maria Duis, Didam (NL); Jan Willem Rietveld, Benschop (NL); Terry Patrick Bowen, Dillsburg, PA (US)

(73) Assignee: Tyco Electronics Corporation, Berwyn, PA (US)

(21) Appl. No.: 12/962,097

(22) Filed: Dec. 7, 2010

(51) Int. Cl. G02B 6/38; G02B 6/26

(52) U.S. Cl. 385/72; 264/1.25

(57) ABSTRACT

In accordance with the invention, the end faces of polymer optical waveguides are coated with a film that is harder than the waveguides themselves, but still sufficiently compliant to fill in scratches, gouges and other non-planarities in the end faces of the waveguides. Even further, using a single continuous sheet of the film to protect the end faces of a plurality of polymer waveguides in a connector also helps make the effective mating surfaces of all of the waveguides coplanar (i.e., longitudinally coextensive). Furthermore, if the film becomes scratched, it can be stripped off and replaced without the need to replace the waveguides or the entire connector.

### FIELD OF THE INVENTION

The invention pertains to fiber optics. More particularly, the invention pertains to optical transports such as polymer optical waveguides that have relatively soft end faces.

### BACKGROUND OF THE INVENTION

Optical transports such as optical fibers and optical waveguides are commonly used to transport data over both short and long distances. Such optical transports often are terminated with an optical connector that allows an end face of the optical transport to mate with the optical interface of another optical component, be it the end face of another optical transport in another optical connector, or a piece of optical or optoelectronic equipment such as an optical receiver having a photodetector for detecting light received through the optical transport or an optical transmitter having a laser transmitter or LED for inputting light into the optical transport. The term “optical component” refers to any optical or optoelectronic component to which a waveguide may be optically coupled. For example, an optical component may be another connector, herein a “mating connector” containing additional optical transports, such as optical waveguides or optical fibers, or it may be apiece of optical or optoelectronic equipment (e.g., passive devices, such as, add/drop filters, arrayed wave guide gratings (AWGs), splitters/couplers, and attenuators, and active devices, such as, optical amplifiers, transmitters, receivers and transceivers). An optical component typically comprises a mating surface which is adapted to receive the mating face of the ferrule to optically couple light to and/or from the waveguide(s).

Typically, the connectors that terminate optical transports are designed to cause the end face of the optical transport to press against the mating surface.

Furthermore, it is most desirable for the end face of an optical transport to be as smooth and flat as possible so that it contacts the mating surface over the entire extent of the optical core of the transport with as few gaps there between in order to maximize optical coupling between the optical transport and the other optical component. The two mating surfaces also should be as close to parallel as possible in order to avoid gaps. Scratches and poorly polished surfaces can significantly increase insertion loss and reduce optical coupling because any air (or even vacuum) in the optical path is likely to substantially increase optical losses across the interface due to the significant difference in the index of refraction of air (or vacuum) and the index of refraction of the optical transports. Gaps substantially increase reflections, i.e., return loss, across the interface. Accordingly, the end faces of the optical transports in an optical connector typically are made as smooth and flat as possible, such as by laser cleaving and/or polishing.

Polishing is relatively expensive and/or time consuming and requires specialized and expensive equipment. Further, it is difficult to laser cleave a polymer waveguide sufficiently flat and smooth due to the typically large cross section of a polymer waveguide (e.g., 250 microns).

Yet further, many optical connectors terminate an optical cable comprising a plurality of optical fibers. For instance, Tyco Electronics, the assignee of the present application manufactures MT style optical connectors adapted to terminate 48 optical transports in one connector. Accordingly, it is a goal to terminate all of the transports in a multi-transport connector so that their end faces are longitudinally coextensive, i.e., as close to coplanar as possible, so as to avoid the situation where the longest transport in a connector (i.e., the one with an end face most forward in the longitudinal direction) makes contact with the mating face of the other optical component, but prevents the shorter fibers from making contact with their mating faces because the meeting of the end face of the longest fiber to its mating surface stops the forward progress of all of the other fibers. Nevertheless, depending on the precision with which the fibers are terminated, polished, and/or cleaved, it is not uncommon for the shortest fibers in a connector containing multiple optical transports to not make contact with their mating surfaces but to leave an undesirable air gap there between.

Traditional optical fibers are fabricated from glass which is rather hard and not particularly prone to scratching during typical handling during fabrication and in the field. However, newer waveguides and other optical transports made of polymers can be much softer than conventional glass optical fibers and, hence, much more difficult to polish effectively and much more prone to scratching during normal use.

### SUMMARY OF THE INVENTION

In accordance with the invention, the end faces of polymer optical waveguides are coated with a film that may be harder than the waveguides themselves, but still sufficiently compliant to fill in scratches, gouges and other non-planarities in the end faces of the waveguides. Even further, using a single continuous sheet of the film to protect the end faces of a plurality of polymer waveguides in a connector also helps make the effective mating surfaces of all of the waveguides coplanar (i.e., longitudinally coextensive). Furthermore, if the film becomes scratched, it can be stripped off and replaced without the need to replace the waveguides or the entire connector.

In a connector that terminates multiple fibers, a single strip of film may be applied over the end face of the connector ferrule so as to cover the end faces of all of the optical transports in the ferrule.

The film may be attached the end face of the ferrule and the end faces of the optical transports in the ferrule by a layer of adhesive. In one embodiment, the film is provided as a strip already bearing the adhesive on one side that can simply be pressed against the ferrule end face to adhere it over all of the polymer optical transports in the ferrule. The film strip may be provided with the adhesive-bearing side covered by a backer strip, which strip may be pulled off just prior to pressing the film strip to the ferrule end face. The adhesive can be cured or heated, if necessary, but, depending on the particular embodiment, simply pressing the film to the end face of the ferrule may be sufficient.

### BRIEF DESCRIPTION OF THE DRAWINGS

FIG. 1 is a breakaway view of an exemplary layer of polymer waveguides.

FIG. 2 is a perspective view of an MT style ferrule terminating a cable containing 48 polymer optical waveguides such as illustrated in FIG. 1.

FIG. 3 is a perspective view of a film strip for terminating the optical transports of the connector of FIG. 2 in accordance with the principles of the present invention.

FIG. 4 is a perspective view of the connector of FIG. 2 after the film has been applied.

### DETAILED DESCRIPTION OF THE INVENTION

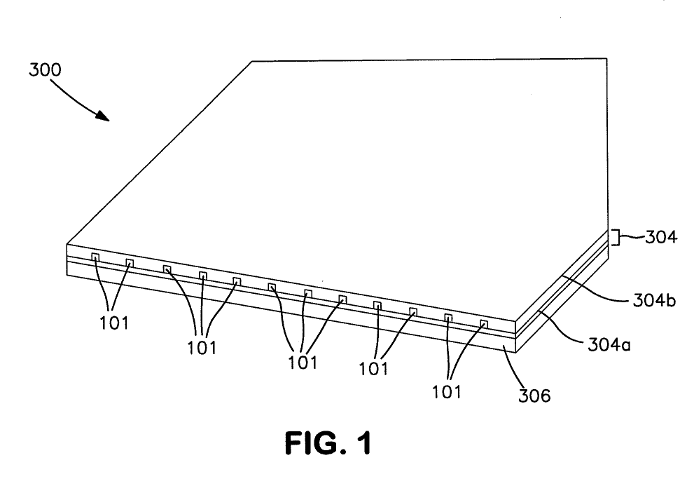

FIG. 1 is a breakaway view of an exemplary layer 300 of polymer optical waveguides such as might form the optical transports in an optical cable terminated by an optical connector. It comprises twelve parallel optical waveguides 101 embedded in planar cladding 304 supported on a polymer mechanical support layer 306. Waveguides typically are manufactured in a planar manner using epitaxial layer processes commonly associated with printed circuit board and semiconductor fabrication. For instance, a first layer 304a of cladding is deposited on top of a mechanical support substrate 306. Then, using conventional photolithography techniques, a plurality of strips of waveguide core material is deposited on top of the first cladding layer 304a to form the waveguides 101. For example, a layer of photoresist is deposited over the first cladding layer 304a and the photoresist is developed through a photolithography mask corresponding to the desired pattern of the waveguides 101 (typically a plurality of parallel strips). Next, the polymer waveguide core material, typically initially a liquid, is deposited over substrate, both filling in the empty strips where the photoresist had been previously removed through the patterning process and covering the remaining, developed photoresist. The polymer is then cured. Next, the remaining photoresist is washed away taking away any of the polymer waveguide core material deposited on it, but leaving the portions of the cured polymer waveguide core material that were deposited directly on the first cladding layer 304a in the empty strips where the photoresist was previously removed. Then, a second layer of cladding 304b is deposited over the first cladding layer 304a and waveguides 101.

FIG. 1 and the above-described process for fabricating such polymer waveguide layers is merely one exemplary way to fabricate polymer optical transports. Other ways are known and it should be understood by those of skill in the related arts that the present invention can be practiced in connection with any form of polymer optical transport or, for that matter, any form of optical transport formed of a material that is softer than desired for purposes of termination and/or optical coupling to another optical component.

The polymer materials from which polymer waveguides are fabricated tend to be softer than glass fibers and glass waveguides. Hence, they are more likely to be scratched or gouged during fabrication, and, particularly, during polishing or microtoming or other cutting processes. In particular, during polishing processes, it is not uncommon for the abrasive particles used for polishing to become lodged in the end faces of polymer waveguides due to the softer consistency of the polymer. Also, it is not uncommon for microtoming processes to leave scratches and gouges in the softer polymer waveguides end faces. Furthermore, when making an optical connection in the field, dust and other particles may become lodged between the optical end faces of the optical transports being connected. Typically, particles do not tend to stick to the end faces of glass optical transports because of their hardness, but they do tend to stick to the end faces of the softer polymer optical transports. Such particles may increase insertion loss across an optical interface, not only because they may block or reflect light in the optical path in which they intervene, but also because they can scratch or gouge the end face of the transport. Even further, particles trapped between the end face of a polymer optical transport and another optical component can prevent the end face of the optical transport from making contact with the other optical component to which it is to optically couple. In fact, this is true not only of the optical transport whose optical path the particle appears in, but, in a multi-transport connector, it could also prevent the end faces of the other, surrounding optical transports from making contact with the optical components to which they are supposed to mate.

Hence, in accordance with the present invention, the end faces of the polymer waveguides are covered with a film of a material that preferably is harder than the polymer waveguide itself and, therefore, more resistant to scratching and gouging and also less prone to attracting dust and other particles. While the film is harder than the polymer waveguide that it covers, the film still preferably is compliant enough to fill gouges and scratches in the end faces of the polymer waveguides it is used to cover so as to minimize or avoid gaps between the optical transport end faces and the film. Likewise, by using a single strip of such a film to terminate a plurality of polymer optical transports in a single connector, the film further helps correct and compensate for differences in the longitudinal co-extensivity of the end faces of the multiple waveguides. Yet further, the compliance of the film will even further help assure the absence of air gaps between the film and the mating surface(s) of the optical component(s) to which the waveguides are being optically coupled. Furthermore, if the film becomes scratched, it can be stripped off and replaced without the need to replace the waveguides or the entire connector.

In one embodiment of the invention, the film is in the form of a strip applied to the end faces of the waveguide or waveguides in the connector. In one embodiment of the invention, a single strip of film is applied to the end face of the ferrule containing one or more polymer waveguides therein. Accordingly, a single strip of the film covers the end faces of all the fibers in the connector.

In one embodiment, the film is applied to the end face of the waveguides via an adhesive. Various adhesives are well-known in the optical coupling arts that have suitable adhering properties, transparency, and indices of refraction to render them appropriate for optical applications such as this where light must pass through them. Since it may be desirable to replace the film if it becomes scratched, another desirable property is the ability to easily remove the adhesive from the end face of a polymer optical transport should it be necessary to replace the film with a new film. For instance, an adhesive that can be readily dissolved in alcohol is preferable. Any of a wide range of adhesives may be used according to the present invention. Examples of suitable adhesives include epoxies, acrylic adhesives, anaerobic and pressure sensitive adhesives, and the like. The adhesives may be curable via ultraviolet (UV) light, heat, or both. A number of UV/heat curable adhesives are available commercially, including: Epotek OG142-13, OG146, and UV0114 (available commercially from Epoxy Technology), OPTOCAST 3553, HM and UTF (available commercially from Electronic Materials Inc.)

In one embodiment, the film is delivered to the connector ferrule as part of a laminate, including a layer of adhesive already borne on one side of the film. For instance, the film may be provided to the site where it will be applied to the end faces of the polymer waveguides as a laminate comprising a first layer of the film, a second layer of adhesive bonded on one side of the film, and a third, backer layer covering the second, adhesive layer, which third layer can be pulled away just prior to application of the laminate to the end face(s) of the waveguide(s).

In one embodiment, the adhesive itself is compliant and performs at least part of the function of filling in any gouges or scratches in the end faces of the waveguides.

In one embodiment, the film has a Shore hardness rating that is harder than the Shore rating of the polymer waveguides, but is still somewhat compliant for the reasons stated above. For instance, polymer waveguides presently typically have Shore D hardnesses of between about 25 and 60. Thus, the film preferably has a Shore hardness between 65 and 90, more preferably between 65 and 70 and, even more preferably, about 70.

Typically, it will be desirable to minimize optical losses across a connection. Hence, it is desirable for the film as well as the adhesive to be as transparent as possible and to have an index of refraction as close as possible to that of the polymer waveguides on which they are mounted. According to certain embodiments, the optical index of the compliant film should differ from the optical index of a multi-mode waveguide by no more than about 10% from the optical index of the wave guide. More preferably, the optical index differs by no more than 3%, and, even more preferably, no more than 2% from the optical index of the waveguide. For certain single-mode embodiments, it is preferred that the optical index of the film differ by no more than 5% from the optical index of the waveguide, more preferably, by no more than 1%, and, even more preferably, no more than 0.5%.

In terms of actual indices, the film may have an optical index of from about 1.35 to about 1.63. As those of skill in the art will recognize, the range of desirable optical indices will differ, at least somewhat, depending on whether the polymer waveguides housed in the connector are multi-mode or single-mode waveguides. According to certain multi-mode embodiments, the film may have an optical index of about 1.35 to about 1.63. Preferably, the optical index of the film is about 1.44 to about 1.53, and even more preferably, about 1.46 to about 1.51. According to certain single-mode embodiments, the film may have an optical index of about 1.40 to about 1.54. Preferably, the optical index of the film is about 1.45 to about 1.50, and even more preferably, about 1.46 to about 1.475.

Also, the film should have a tensile strength sufficient to avoid tearing or puncturing during assembly and when making connections to other optical components and to survive multiple connections to the mating surfaces of optical components. Mating surfaces, for instance, may include optical glass fibers or other sharp components that could scratch or even puncture the film during coupling of the connector to another optical component. In fact, the film could be damaged by debris during normal handling during or after installation. Accordingly, in a preferred embodiment, the film has a tensile strength of greater than 100 N/mm.sup.2.

The thickness of the film for use in any application according to the principles of the present invention should be selected to optimize a number of competing factors including, for example, the optical spreading and loss across the film, the tensile strength of the film, and the compliance of the film. In general, thinner films will exhibit lower transmissive loss therethrough. However, also as noted above, the film should be sufficiently thick to ensure the film will have acceptable tensile strength so as not to be damaged during the coupling of the connector to other optical components and should be able to survive several hundred couplings without breakage or delamination from the end face(s) of the polymer optical transports.

The film should be thick enough to have sufficient strength and provide sufficient compliance in the longitudinal direction of the optical connection. For this reason, films having a thickness of 5 microns or greater may be desirable. On the other hand, the film should not be made too thick because the light passing through the film is unrestrained and spreading. If the film is too thick, it may lead to cross talk between channels as well as insertion loss in a given channel. Thicknesses of less than 25 and more preferably less than 20 microns are desirable. According to certain embodiments, the film and adhesive collectively has a thickness of from about 5 microns to about 25 microns. Preferably, the thickness is from about 10 microns to about 20 microns, and more preferably about 15 microns, comprising a 10 micron thick layer of film with a 5 micron thick layer of adhesive.

The ferrule connector may be an MT-type connector for example, the Lightray MPX connector, or the MTO connector. Aside from multi-wave guide ferrule connectors, the present invention may be practiced with single ferrule connectors, such as the MU, LC, ST, FC, and SC connectors. The invention is also particularly well suited for field-installable connectors. As used herein, the term “field-installable connector” refers generally to any optical connector that is at least partially assembled on-site, that is, at the site where the connector is to be used for a particular connecting application.

The film may be formed of a wide array of materials Examples of suitable materials include polyalkylenes, such as, for example, polypropylene, especially biaxial-oriented polypropylene, as well as, polyimides, fluorinated polyimides, polyesters, nylons, silicone resins, acrylic resins, and the like. According to certain preferred embodiments, the film of the present invention is a polypropylene film since it is transparent to the wavelengths typically used in optical communication, i.e., 850 to 1630 nm. A variety of the aforementioned suitable materials are available commercially, including, for example, Kopa AC polypropylene film (available commercially from Spezialpapierfabrik Oberschmitten GMBH), Kynar film (available commercially from Avery Dennison), polyester films (available commercially from DuPont), and Dartek Nylon film (available commercially from DuPont).

One particularly suitable film for use in the present invention is the FitWell film available from Tomoegawa Co. Ltd. This product is available prepackaged as small strips or decals with the adhesive already on it and a backing film that can be pulled off just prior to application and of suitable size for application directly to the end faces of MT and other ferrules without the need for additional cutting. U.S. Pat. No. 7,422,375, incorporated fully herein by reference, also discloses films that should be suitable for use in the present invention.

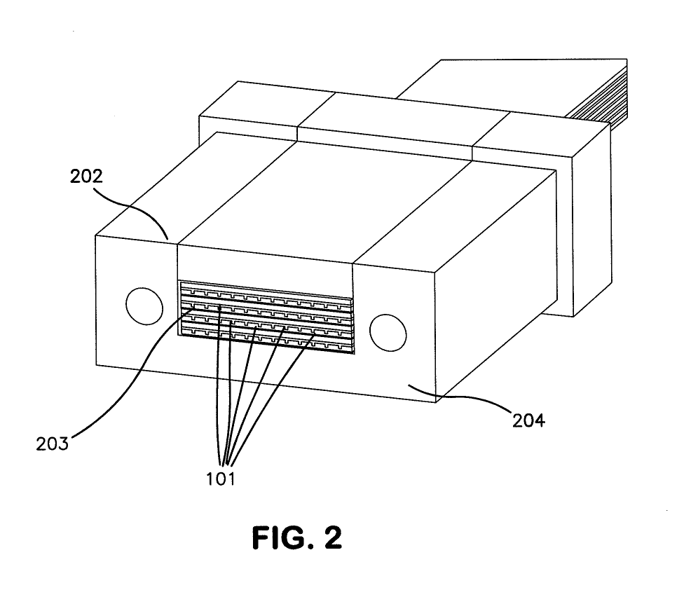

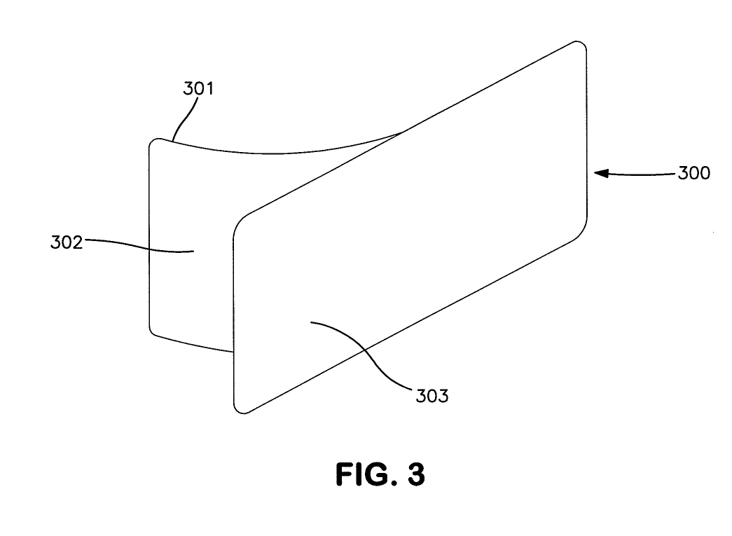

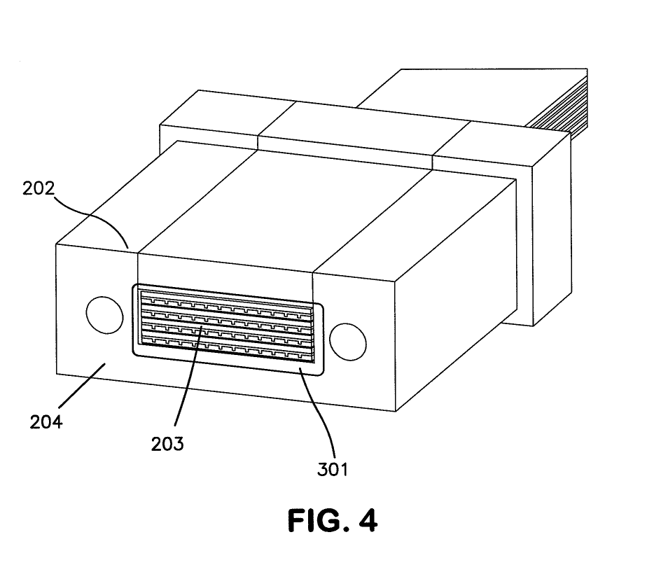

In one exemplary assembly process in accordance with the principles of the present invention and with reference to FIG. 2, a ferrule 202 is presented including at least one longitudinal bore 203 and the polymer waveguides 101 are assembled into the ferrule 202 and the polymer waveguide end faces are cut such as by microtome cutting to form rough end faces of the waveguides. Preferably, the waveguides 101 are not polished or laser cleaved, leading to significant cost and time savings. Furthermore, the elimination of polishing also avoids the possibility of abrasive particles from the polishing equipment becoming lodged in the end faces of the polymer waveguides. Next, referring to FIG. 3, a strip of laminate 300 comprising the hard film 301, a layer of adhesive 302 on one side thereof and a backer layer 303 covering the adhesive-bearing side of the film is brought to the ferrule 202. The backer layer 303 is removed from the strip 300 (as partially illustrated in FIG. 3) and then, as illustrated in FIG. 4, the adhesive-bearing side of the film 301 is pressed against the end face 204 of the ferrule 202 so as to cover all of the end faces of the polymer waveguides 101, as illustrated in FIG. 4. The film 301 may cover only the waveguides and their surrounding cladding and substrate within the bore 203. However, in the illustrated embodiment, the film strip 301 is larger than the bore so that the edges of the strip 301 contact the end face 204 of the ferrule also and the strip becomes adhered to the ferrule 202 in addition to the waveguides 101.

While the process of applying the film to the end faces of the polymer waveguides may be as simple as pressing the adhesive-bearing side to the end face of the ferrule, it may also comprise additional aspects, such as treating the film and/or adhesive so that the film and/or adhesive has a fluid tendency that allows it to flow into the gaps between the film and the mating end face of the waveguide. Suitable film treatments include, for example, heating, chemically reacting one or more components of the film and/or adhesive, and applying high pressure to the film. For instance, the application of sufficient heat to the film and/or adhesive tends to soften or even slightly liquefy the film and/or adhesive to facilitate the flow of the film and/or adhesive to fill gaps, scratches, and gouges in the end face of the waveguides. Then, when the heat is removed, it solidifies in that shape, essentially embossing itself to the end face of the waveguide and filling in any scratches gouges, digs, voids, or other non-planarities. A wide range of heat sources can be used to apply heat to the film in accordance with the present invention. Suitable heat sources include, for example, laser welders, torches, and heat guns.

As previously described, the adhesive and/or the film itself will fill in any gouges or scratches in the waveguide end faces as well as make the effective ends of all of the optical paths of the waveguides in the ferrule essentially coplanar.

Having thus described the few particular embodiments of the invention, various alterations, modifications, and improvements should be apparent to persons of skill in the related arts. Such alterations, modifications, and improvements as I made obvious by this disclosure are intended to be part of this description though not expressly stated herein, and are intended to be within the spirit and scope of the invention. Accordingly, the foregoing description is by way of example only, and not limited. The invention is limited only as defined in the following claims and equivalences thereto.

1. An optical connector comprising:
a ferrule having an optical end face having at least one longitudinal bore for receiving a polymer waveguide therethrough;
at least one polymer waveguide in the at least one bore, the polymer waveguide having an optical end face presented for optical coupling to an optical component at the end face of the ferrule; and
a film disposed over the end face of the at least one polymer waveguide.

2. The optical connector of claim 1 wherein the film is harder than the polymer waveguide.

3. The optical connector of claim 2 wherein end face of the polymer waveguide is non-planar and wherein the film is compliant and fills in non-planarities in the end face of the polymer waveguide so as to avoid air gaps between the end face of the at least one polymer waveguide and the film.

4. The optical connector of claim 3 wherein the connector comprises a plurality of polymer waveguides with optical end faces presented for optical coupling at the end face of the ferrule and wherein the film comprises a single strip of film disposed over the end faces of all of the polymer waveguides.

5. The optical connector of claim 4 further comprising adhesive between the end faces of the polymer waveguides and the film.

6. The optical connector of claim 5 wherein the adhesive comprises a layer of adhesive applied to one side of the film.

7. The optical connector of claim 6 wherein the film has a Shore hardness of between 65 and 90.

8. The optical connector of claim 6 wherein the first layer is biaxial oriented polypropylene.

9. The optical connector of claim 7 wherein the film is between 5 and 20 microns thick.

10. The connector of claim 9 wherein the film is between 10 and 15 microns thick and the layer of adhesive is approximately 5 microns thick.

11. The connector of claim 4 wherein the film is adhered to the end face of the ferrule and the end faces of the plurality of polymer waveguides.

12. A method of manufacturing an optical connector comprising:
presenting a ferrule having an optical end face defining at least one longitudinal bore for receiving a polymer waveguide therethrough;
placing at least one polymer waveguide in the longitudinal bore with an end face thereof presented at the end face of the ferrule for optical coupling to an optical component; and
providing a compliant film having a hardness greater than a hardness of the at least one polymer waveguide over the end face of the at least one polymer waveguide.

13. The method of claim 12 wherein the placing occurs prior to the providing.

14. The method of claim 13 wherein the providing comprises adhering the compliant film to the end face of the ferrule and to the end face of the at least one polymer waveguide.

15. The method of claim 14 wherein the providing comprises providing a laminate comprising a first layer comprising the film bearing a second layer comprising an adhesive on a first side of the film and applying the laminate to the end face of the ferrule with the first side of the film facing the ferrule.

16. The method of claim 15 wherein the providing comprises:
providing a strip of the film of a size that will cover the end faces of all of the plurality of polymer waveguides; and
pressing the film against the end face of the ferrule with the first side facing the ferrule.

17. The method of claim 12 further comprising:
cutting the at least one polymer waveguide after the placing and before the providing.

18. The method of claim 17 wherein the cutting comprises microtoming.

19. The method of claim 14 wherein the applying comprises pressing the film against the end face of the ferrule with the first side facing the ferrule and filling in any non-planarities in the end face of the polymer waveguide with at least one of the first layer and the second layer of the film.

20. The method of claim 12 wherein the end face of the at least one polymer waveguide is unpolished.
